(19) United States
(12) Patent Application Publication
(10) Pub. No.: US 2013/0181455 A1
(43) Pub. Date: Jul. 18, 2013

(54) Large scale disc-type multi-stator permanent magnet direct-drive wind power generator

(71) Applicants: Wenjiang Shi, Beijing (CN); Shancai Xiao, Beijing (CN)

(72) Inventors: Wenjiang Shi, Beijing (CN); Shancai Xiao, Beijing (CN)

(73) Assignee: GUODIAN UNITED POWER TECHNOLOGY CO., LTD, BEIJING (CN)

(21) Appl. No.: 13/391,620

(22) PCT Filed: Jul. 25, 2011
(86) PCT No.: PCT/CN2011/001210

§ 371 Date: Feb. 21, 2012

(30) Foreign Application Priority Data
Jul. 6, 2011 (CN) 201110188209.1

(51) Int. Cl. F03D 11/00

(52) U.S. Cl. CPC F03D 11/005
USPC 290/55

(57) ABSTRACT

The present invention is a large scale disc-type multi-stator permanent magnet direct-drive wind power generator which mainly comprises a hub (1), a rotor shaft (5), a stationary shaft (11), a bracket (16) and a plurality of generator units, wherein: the stationary shaft (11) is fixed to the bracket (16); the rotor shaft (5) is fixed to the hub (1) and is rotatably mounted on the stationary shaft (11); each of the generator units comprises a disc-type winding (10) and permanent magnets (6) disposed on two sides of the disc-type winding (10); each of the disc-type windings (10) of the generator units is fixedly connected to the casing (8); each of the disc-type windings (10) comprises a plurality of rectangular spiral windings which are connected in series, and ends of the connected windings are guided via wires to an exterior of the casing to connect in series or in parallel with other disc-type windings; permanent magnets (6) are fixed on the rotor shaft (7) via rotor rotating discs (5). The present invention makes use of a disc-type multi-stator structure which fully utilizes the internal space of the rotors and increases the power density of the generator. It also reduces the longitudinal and axial sizes of the wind generators, and effectively lower generator weight and costs.

### BACKGROUND OF THE INVENTION

The present invention relates to a disc-type wind power generator and more particularly pertains to a large scale disc-type multi-stator permanent magnet direct-drive wind power generator.

With the global and ever increasing demand in wind power, bigger challenges have been raised regarding the technological advancement and the production costs of wind power generators. At present, large scale megawatt-class permanent magnet direct-drive wind generators are large in size, so both their weights and production costs are high. Therefore, the reduction of the size, the weight and the production costs of large scale permanent magnet direct-drive wind generators has been a meaningful topic in this field.

### BRIEF SUMMARY OF THE INVENTION

The present invention aims to provide a large scale disc-type multi-stator permanent magnet direct-drive wind power generator with reduced size, weight and costs, therefore overcoming the disadvantages of large size, weight and costs of present large scale permanent magnet direct-drive wind generators.

To attain this, the large scale disc-type multi-stator permanent magnet direct-drive wind power generator mainly comprises a hub, a rotor shaft, a stationary shaft, a bracket, a casing and a plurality of generator units which are longitudinally stacked, wherein: the stationary shaft is fixed to the bracket; the rotor shaft is fixed to the hub and is rotatably mounted on the stationary shaft; each of the generator units comprises a disc-type winding and permanent magnets disposed on two sides of the disc-type winding; each of the disc-type windings of the generator units is fixedly connected to the casing; each of the disc-type windings comprises a plurality of rectangular spiral windings which are connected in series, and ends of the connected windings are guided via wires to an exterior of the casing to connect in series or in parallel with other disc-type windings; a plurality of the generator units form a power generating component of the generator; permanent magnets are fixed on the rotor shaft via rotor rotating discs.

The disc-type windings, the rotor rotating discs and the casing of the present invention are all formed by two semi-circular structures respectively.

The disc-type winding comprises rectangular spiral windings which are in form of printed circuit board winding structure or embedded in winding disc.

The permanent magnets are radially arranged on the rotor rotating discs.

The rotor shaft is mounted on the stationary shaft via a front bearing and a rear bearing.

A shaft sleeve is disposed between the stationary shaft and the front and rear bearings.

The rotor rotating discs are assembled with the rotor shaft via bolts, retaining nuts and positioning pins.

The hub is fixed to a front end of the rotor shaft via bolts.

Winding slots are provided in inner sides of the casing; each of the winding slots is provided with a winding locking ring, puller bolts and winding pressing pieces, and the disc-type windings are fixed in the winding slots of the casing with the winding locking rings, the puller bolts and the winding pressing pieces.

With the aforementioned structures, the large scale disc-type multi-stator permanent magnet direct-drive wind power generator of the present invention makes use of a disc-type multi-stator structure in megawatt class wind generators, thereby fully utilizes the internal space of the rotors which is basically vacant in conventional direct-drive wind generators, and thus significantly increases the power density of the generator. Therefore, the longitudinal and axial sizes of the large scale permanent magnet direct-drive wind generators are reduced, and the weight and costs of the generators are also effectively lowered.

### BRIEF DESCRIPTION OF THE DRAWINGS

The aforementioned is only a summary of the present invention. For better illustration, the present invention is further described with the preferred embodiment and the accompanying drawings.

FIG. 1 illustrates the structure of the large scale disc-type multi-stator permanent magnet direct-drive wind power generator of the present invention.

FIG. 2 illustrates the winding positioning member of the large scale disc-type multi-stator permanent magnet direct-drive wind power generator of the present invention.

FIG. 3 is a cross-sectional view along line B-B in FIG. 2

FIG. 4 illustrates the rotating disc fixing member of the large scale disc-type multi-stator permanent magnet direct-drive wind power generator of the present invention.

FIG. 5 is a view from the direction of A in FIG. 4.

### DETAILED DESCRIPTION OF THE INVENTION

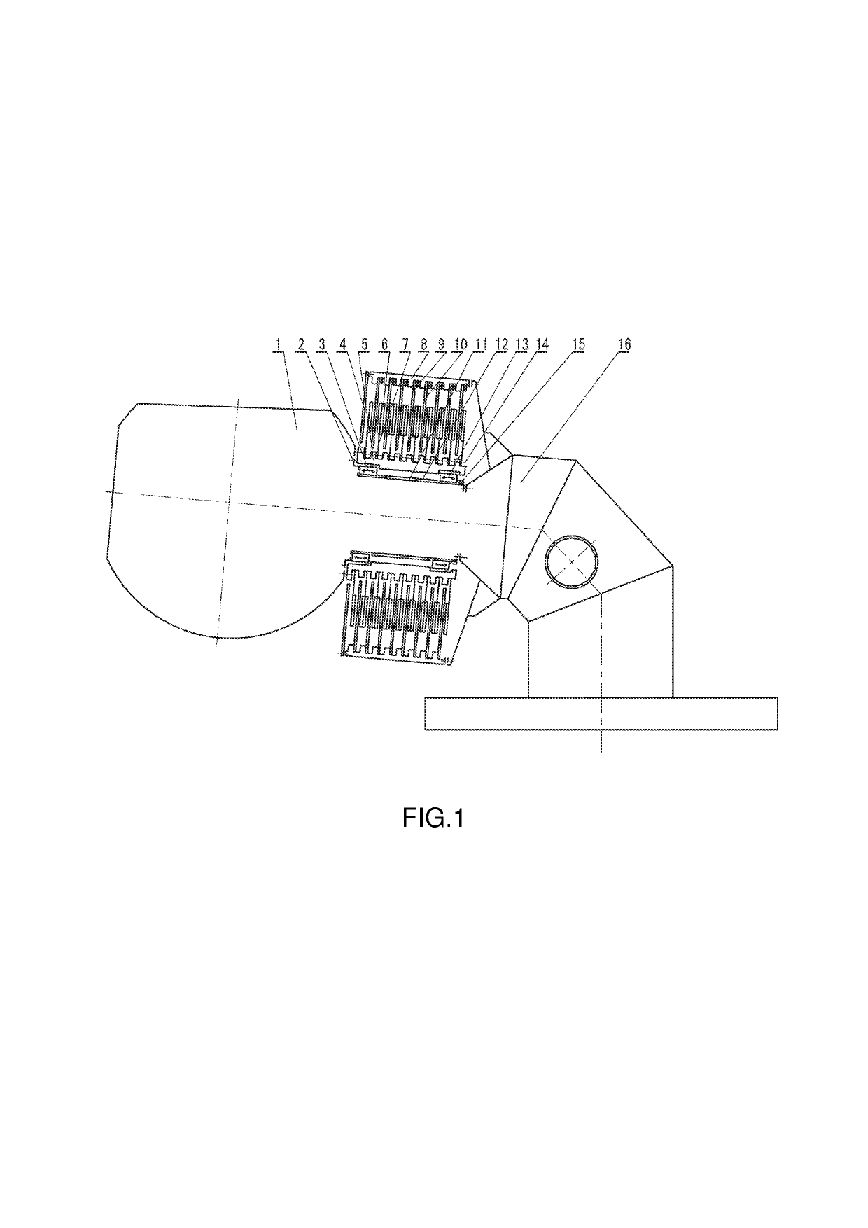

As illustrated in FIG. 1, the large scale disc-type multi-stator permanent magnet direct-drive wind power generator mainly comprises a hub 1, a rotor shaft 5, a stationary shaft 11, a bracket 16, a casing 8 and a plurality of generator units which are longitudinally stacked.

The stationary shaft 11 is fixed to the bracket 16 via spindle nuts 15. The hub 1 is fixed to a front end of the rotor shaft 5 via bolts. The front end of the rotor shaft 5 is disposed in its interior with a front end cover 4 to seal the bearings.

The rotor shaft 5 is rotatably mounted on the stationary shaft 11 via a front bearing 3 and a rear bearing 13. A shaft sleeve 12 is disposed between the stationary shaft and the inner races of the two bearings. The axial thrust of the hub is transmitted to the stationary shaft 11 and the bracket 16 via the rotor shaft 5, the rear bearing 13 and the spindle nuts 15.

Each of the generator units comprises a disc-type winding 10, and permanent magnets 6 disposed on two sides of the disc-type winding 10. The power generating component of the generator is composed of a plurality of the generator units.

The disc-type windings 10 may take the form of printed circuit board winding structure or embedded winding structure. Each of the disc-type windings 10 may comprise a plurality of rectangular spiral windings. The disc-type windings 10 are installed in slots of the casing 8 via winding fixing members 9. A plurality of the spiral windings on a single disc connect in series, and ends of the windings connected in series are then guided via wires to an exterior of the casing 8 to connect in series or in parallel with wires from other discs.

The permanent magnets 6 are radially arranged on rotor rotating discs 7. The rotor rotating discs 7 are fixed on the rotor shaft 5 via rotating disc fixing members 14.

The disc-type windings 10, the rotor rotating discs 7 and the casing 8 are all formed by two semi-circular structures respectively. The semi-circular disc-type windings 10 form two semi-circular assembled bodies with the winding fixing members 9 and the semi-circular casings 8 respectively, which are then integrated with the rotor rotating discs 7, thereby enabling simpler installation. Each of the semi-circular disc-type windings have at least two ends which are guided to the exterior of the casing so as to connect with wires from other disc-type windings.

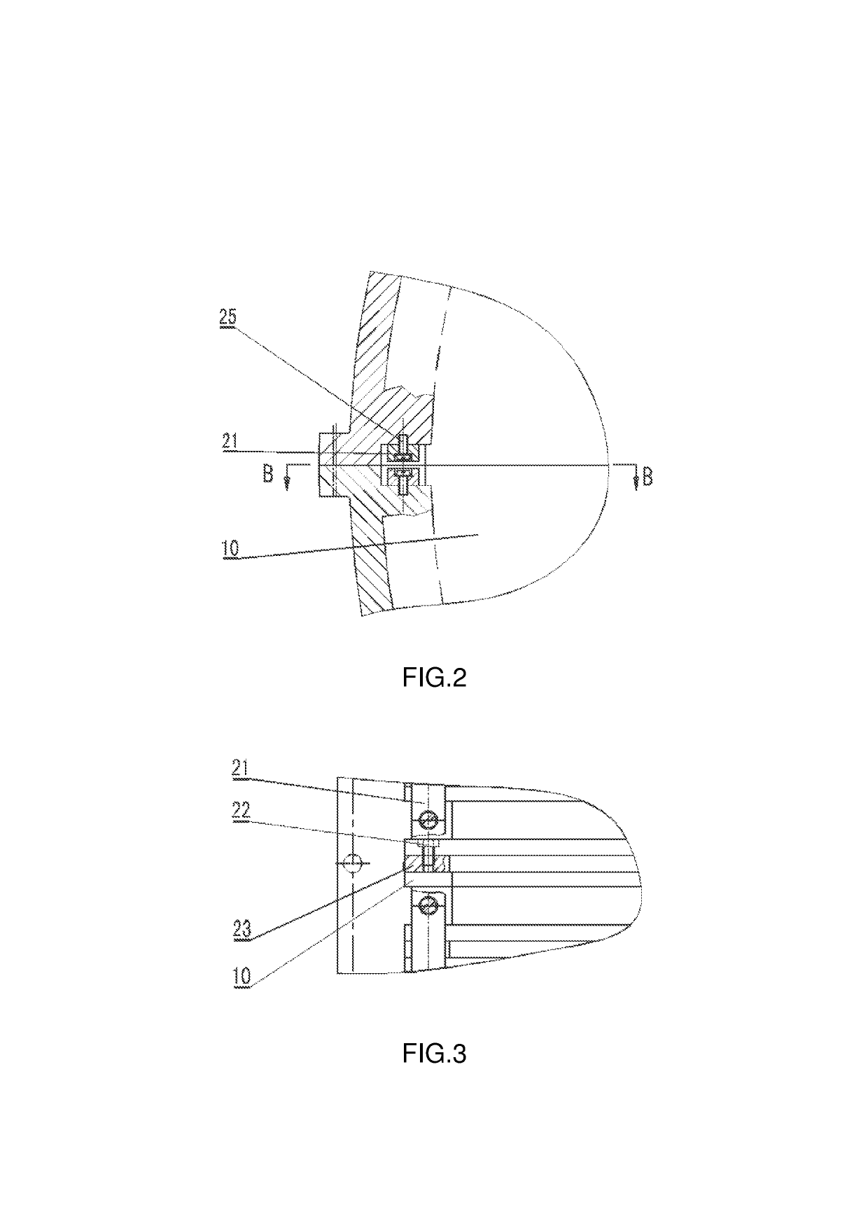

As illustrated in FIGS. 2 and 3, the winding fixing member 9 comprises winding pressing pieces 21, puller bolts 22 and a winding locking ring 23. First, the semi-circular disc-type winding 10 is installed in the slot of the casing 8, the winding locking ring 23 which is in shape of a half-ring is then installed. Each of the half-ring is circumferentially disposed with a plurality of puller bolts 22 to axially fix the disc-type winding 10. Axial slots are provided in inner sides of the middle split surfaces of the upper and lower casings. The winding pressing pieces 21 are installed in the axial slot using screw 25, and the disc-type winding 10 is pressed and fixed axially. There are two winding pressing pieces 21 at each of the upper and lower halves, so there are four in total. The upper and lower casings are assembled together with bolts, screws and positioning pins.

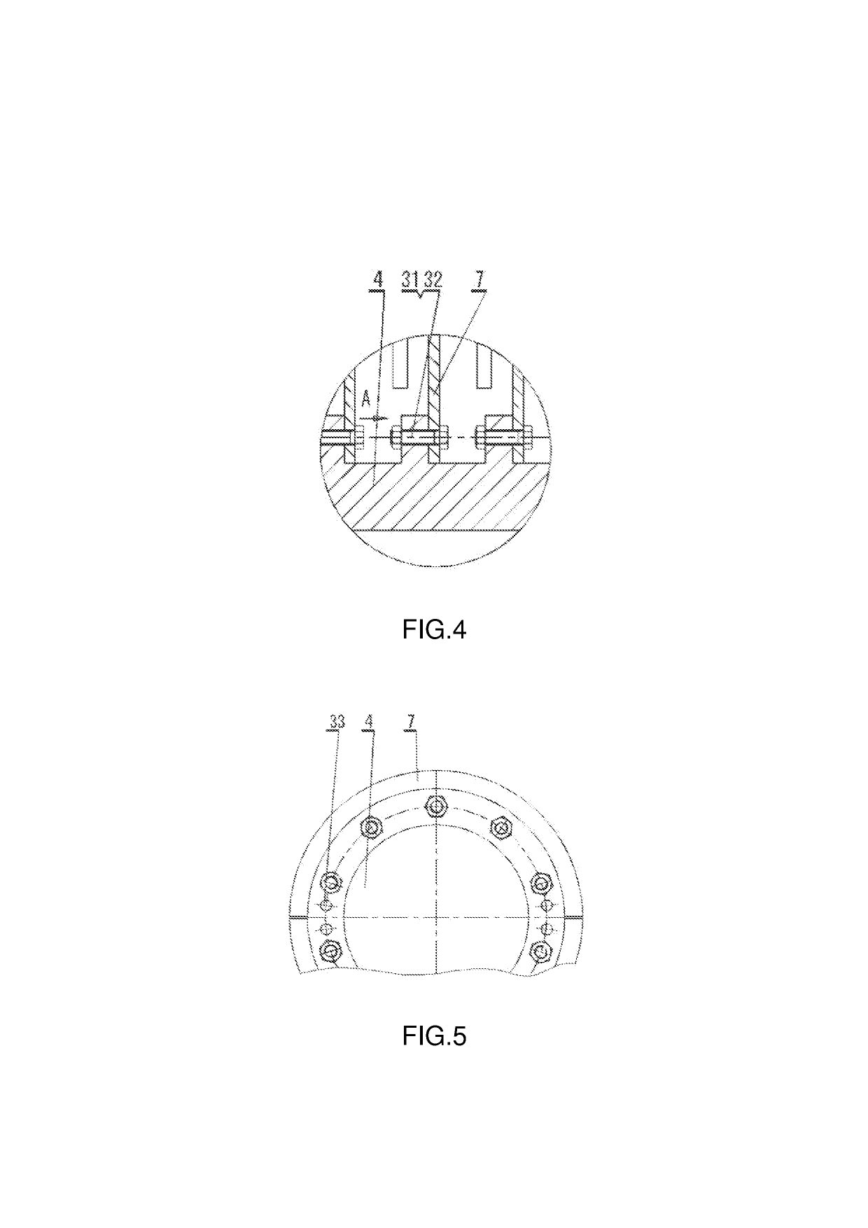

As illustrated in FIGS. 4 and 5, the rotating disc fixing member 14 comprises bolt 31, retaining nut 32 and positioning pin 33. Each of the semi-circular rotor rotating discs 7 is fixed on a flange of the rotor shaft 5 with a plurality of bolts 31 and retaining nuts 32, and is locked in position with the positioning pin 33.

The short center lines in the figures represent bolts and nuts of different standards. In the present invention, various loads of the hub 1 are transmitted to the bracket 16 via the rotor shaft 5, the front bearing 3, the rear bearing 13, the spindle nuts 15 and the stationary shaft 16. One disc-type winding 10 and the permanent magnets 6 serving as rotors on two sides thereof form an independent magnetic path which passes through the winding enclosing the path to form a generator unit. Stacking a plurality of identical generator units in a generator casing and connect the windings in series or in parallel according to design needs would then form the power generating component of the generator.

As the present invention fully utilizes the internal space of the casing 8, it has significantly smaller size, weight and costs in comparison with conventional direct-drive wind generators.

The aforementioned are only preferred embodiments of the present invention which are not intended to restrict the present invention in any ways. Simple amendments, equivalent changes or alterations made by the person skilled in the art with the aforementioned technical disclosure also fall within the scope of the present invention.

What is claimed is:

1. A large scale disc-type multi-stator permanent magnet direct-drive wind power generator, characterized in that it mainly comprises a hub, a rotor shaft, a stationary shaft, a bracket, a casing and a plurality of generator units which are longitudinally stacked, wherein: the stationary shaft is fixed to the bracket; the rotor shaft is fixed to the hub and is rotatably mounted on the stationary shaft; each of the generator units comprises a disc-type winding and permanent magnets disposed on two sides of the disc-type winding; each of the disc-type windings of the generator units is fixedly connected to the casing; each of the disc-type windings comprises a plurality of rectangular spiral windings which are connected in series, and ends of the connected windings are guided via wires to an exterior of the casing to connect in series or in parallel with other disc-type windings; a plurality of the generator units form a power generating component of the generator; permanent magnets are fixed on the rotor shaft via rotor rotating discs.

2. The large scale disc-type multi-stator permanent magnet direct-drive wind power generator as in claim 1, characterized in that the disc-type windings, the rotor rotating discs and the casing are all formed by two semi-circular structures respectively.

3. The large scale disc-type multi-stator permanent magnet direct-drive wind power generator as in claim 1, characterized in that the disc-type winding comprises rectangular spiral windings which are in form of printed circuit board winding structure or embedded in winding disc.

4. The large scale disc-type multi-stator permanent magnet direct-drive wind power generator as in claim 1, characterized in that the permanent magnets are radially arranged on the rotor rotating discs.

5. The large scale disc-type multi-stator permanent magnet direct-drive wind power generator as in claim 1, characterized in that the rotor shaft is mounted on the stationary shaft via a front bearing and a rear bearing.

6. The large scale disc-type multi-stator permanent magnet direct-drive wind power generator as in claim 5, characterized in that a shaft sleeve is disposed between the stationary shaft and the front and rear bearings.

7. The large scale disc-type multi-stator permanent magnet direct-drive wind power generator as in claim 1, characterized in that the rotor rotating discs are assembled with the rotor shaft via bolts, retaining nuts and positioning pins.

8. The large scale disc-type multi-stator permanent magnet direct-drive wind power generator as in claim 1, characterized in that the hub is fixed to a front end of the rotor shaft via bolts.

9. The large scale disc-type multi-stator permanent magnet direct-drive wind power generator as in any of the claims 1-8, characterized in that winding slots are provided in inner sides of the casing; each of the winding slots is provided with a winding locking ring, puller bolts and winding pressing pieces, and the disc-type windings are fixed in the winding slots of the casing with the winding locking rings, the puller bolts and the winding pressing pieces.
